(19) United States
(12) Patent Application Publication
(10) Pub. No.: US 2004/0093252 A1
(43) Pub. Date: May 13, 2004

(54) Examination scheduling program for nuclear medical examination apparatus

(76) Inventor: Masami Maekawa, Kyoto (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/653,193

(22) Filed: Sep. 3, 2003

(30) Foreign Application Priority Data
Sep. 12, 2002 (JP) JP2002-266400

(51) Int. Cl. G06F 17/60

(52) U.S. Cl. 705/8; 705/3

(57) ABSTRACT

An examination scheduling program for a nuclear medical examination apparatus for causing a computer to create a schedule for each patient including an examination by the nuclear medical examination apparatus and a medication accompanying the examination. The program includes a step of fetching information on contents of the examination for each patient and an order of examinations, and a step of creating an examination schedule to avoid overlapping in time of timing of the medication and the examinations according to the information on the contents of the examination and the order of examinations, while maintaining fixed a waiting time from the medication to the examination set for each patient according to a type of examination.

### BACKGROUND OF THE INVENTION

1. Field of the Invention

This invention relates to an examination scheduling program for nuclear medical examination apparatus, for creating a schedule of medical examinations using a nuclear medical examination apparatus such as a positron CT apparatus that produces distribution images of positron-emitting RI (radioactive isotopes) distributed in patients, or a gamma camera.

2. Description of the Related Art

In an examination using a positron CT apparatus which is one type of nuclear medical examination apparatus, it is necessary to administer the patient an injection of glucose containing positron-emitting RI, a certain time (e.g. one hour) before collecting emission data. This is because a certain amount of time is taken to distribute the positron-emitting RI to cancer cells that could be present in the tissues of a site of concern. That is, a certain waiting time is required until an emission data collecting examination after the medication.

When, for example, examinations using the positron CT apparatus are conducted for a plurality of patients, stop watches corresponding in number to the patients are made available, and a period of time the positron CT apparatus is used for each patient is written on paper so as to avoid overlapping with periods of time allocated to the other patients. A medication time for each patient is determined by counting backward from a waiting time, and is also noted down on paper.

The conventional practice noted above has the following drawbacks.

In the conventional practice, a detailed scheduling is impossible because of the necessity to schedule examinations in a way to accommodate some contingencies. This poses a problem that the operating ratio of the positron CT apparatus cannot be improved easily.

Particularly where different examinations are conducted for a plurality of patients, for example, a certain patient may receive a transmission data collecting examination and an emission data collecting examination separately, and a different patient may undergo a transmission data collecting examination and an emission data collecting examination simultaneously. In such a case, the former is given medication after the transmission data collecting examination, and the emission data collecting examination is conducted after a certain waiting time. The latter is given medication before the transmission and emission data collecting examinations.

It is therefore difficult to determine time relations among the plurality of examinations. In order to determine a medication time for a patient receiving a next examination, it is necessary to derive a time for starting the next examination from a scheduled finishing time of an examination currently in progress, and further to deduce a waiting time by counting backward from the starting time derived. Since an extremely complicated operation is required to determine a medication time as noted above, it is likely to obtain a wrong medication time. It is practically difficult to fix a waiting time for each examination.

Furthermore, when an alteration occurs with any of a plurality of examinations, it is difficult to determine which examinations are influenced by the alteration and an extent of change in time resulting therefrom. Such a situation tends to cause failures to record times and to start examinations, a mistiming of medication, and other errors relating to time management.

In order to determine whether the time management of examinations is performed appropriately, it is necessary to refer to time records handled separately from examination results and written or printed on paper. This constitutes a very troublesome checking operation.

### SUMMARY OF THE INVENTION

This invention has been made having regard to the state of the art noted above, and its object is to provide an examination scheduling program for a nuclear medical examination apparatus, which easily improves the operating ratio of the nuclear medicinal examination apparatus by avoiding overlapping in time between examinations of patients and timing of medication based on information on contents of the examinations and the order of the examinations, and by a scheduling to fix a waiting time according to the type of examination, and which facilitates a re-scheduling due to an alteration while maintaining the fixed waiting time set according to the type of examination.

The above object is fulfilled, according to this invention, by an examination scheduling program for a nuclear medical examination apparatus for causing a computer to create a schedule for each patient including an examination by the nuclear medical examination apparatus and a medication accompanying the examination, the program comprising a step of fetching information on contents of the examination for each patient and an order of examinations, and a step of creating an examination schedule to avoid overlapping in time of timing of the medication and the examinations according to the information on the contents of the examination and the order of examinations, while maintaining fixed a waiting time from the medication to the examination set for each patient according to a type of examination.

When information on the contents of the examination for each patient and an order of examinations is given, a medication and the examination required for each patient are determined according to these contents. Such information is taken in, and an examination schedule is determined in a way to avoid overlapping in time of timing of the medication and the examinations according to the information on the contents of the examination and the order of examinations, while maintaining fixed a waiting time from the medication to the examination set for each patient according to the type of examination. This readily improves the operating ratio of the nuclear medical examination apparatus, and uniforms the waiting time for each examination.

Preferably, the schedule for each patient is expressed by a pattern having a time span according to the type of examination, the pattern presenting the timing of the medication, the waiting time and the contents of the examination.

A re-scheduling may be made easily to cope with an alteration since the current schedule may be grasped immediately only by looking at the arrangement of patterns.

Preferably, the schedule for each patient is displayed in form of a pattern on a time chart, with a line representing present time displayed to move on the time chart with progress of time.

A time relationship between the medication or examination and the present time is displayed in real time. Thus, an operation to be performed next is displayed in a simple and plain way.

Preferably, the schedule is altered by moving the pattern on the time chart with a pointing device.

The schedule may be altered intuitively and easily for each patient while checking the state of the entire schedule.

Preferably, the schedule for each patient is under control, and a correlation is made between actual measurements including actual medication and examination times, and data collected by the nuclear medical examination apparatus.

A deviation from the schedule can be determined by correlating actual measurements including actual medication and examination times, and collected data. This enables appropriateness of the time management of examinations to be determined easily.

Preferably, the program further comprises a step of inputting an actual medication time, a step of comparing a scheduled medication time and the actual medication time, and a step of creating an examination schedule all over again when the step of comparing shows a disagreement.

Medication is an operation performed by a human or for a human, and may not be carried out according to schedule. An actual medication time may deviate from a scheduled time. This may be caused, for example, by a delay in preparing a liquid medicine, or the patient failing to visit the hospital before a scheduled medication time. Such a situation is determined by comparing an actual medication time and a scheduled medication time. When the result shows a disagreement, a scheduling is carried out again. In this way, a subsequent schedule may be altered automatically, to avoid subsequent examinations becoming hectic.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a block diagram showing an outline of a positron CT apparatus according to this invention;

FIG. 2 is a schematic view showing relations among 0.7 various functions in an examination scheduling program for the positron CT apparatus;

FIG. 3 is a view showing contents of a reservation calendar displayed in a week view;

FIG. 4 is a view showing contents of patient information in a patient information file;

FIG. 5 is a view showing contents of study series information in the patient information file;

FIG. 6 is a view showing contents of detailed parameter setting information accompanying the study series information in the patient information file;

FIG. 7 is a schematic view showing a scheduling made for designated examinations of patients and in a designated order of examinations;

FIG. 8 is a view showing contents of the reservation calendar displayed in a day view;

FIGS. 9A and 9B are schematic views showing an alteration made to a schedule on the reservation calendar displayed in the day view, in which FIG. 9A shows a dragging action, and FIG. 9B shows a state after the dragging;

FIG. 10 is an explanatory view showing movement of the present time on the reservation calendar displayed in the day view; and

FIG. 11 is a view showing a collection panel displayed in time of examination.

### DESCRIPTION OF THE PREFERRED EMBODIMENTS

A preferred embodiment of this invention will be described in detail hereinafter with reference to the drawings.

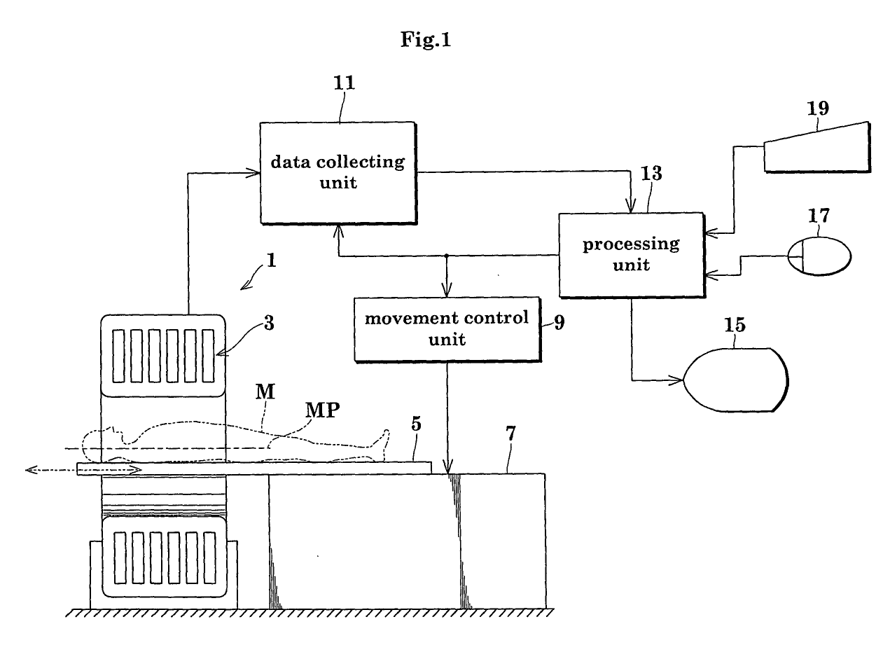

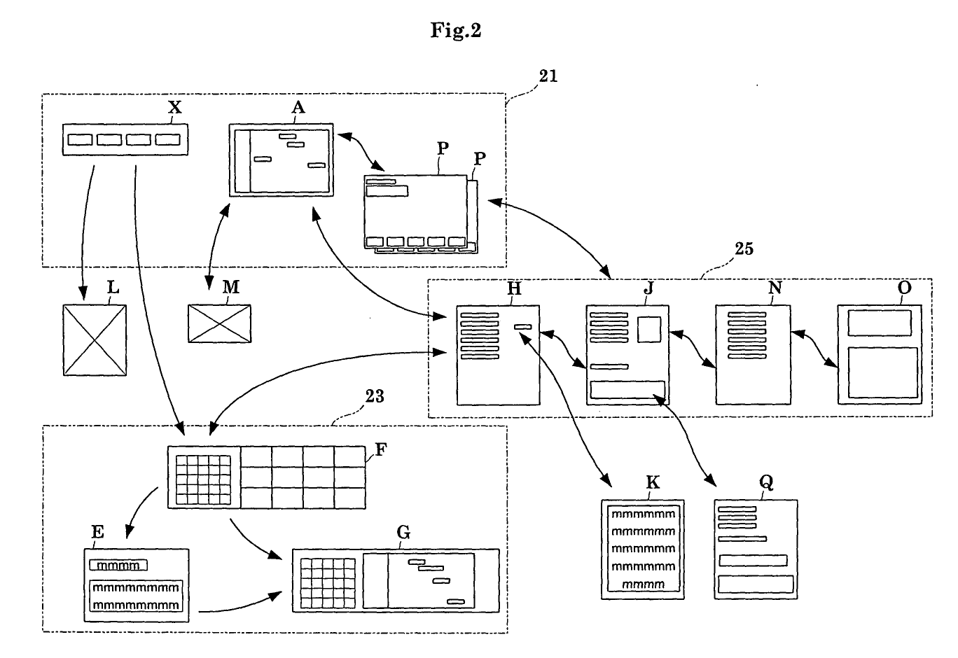

FIGS. 1 and 2 show an embodiment of this invention. FIG. 1 is a block diagram showing an outline of a positron CT apparatus according to this invention. FIG. 2 is a schematic view showing relations among various functions in an examination scheduling program for the positron CT apparatus

A gantry 1 having a center opening includes a multi-ring type detector 3 with radiation detectors arranged in a ring form. The detector 3 has, for example, six ring type detectors arranged coaxially along the axis of the opening of the gantry 1. The ring type detectors are arranged with the centers thereof spaced at fixed intervals.

Arranged in front of the gantry 1 are a bed 5 movable into and out of the opening of the gantry 1, and a bed moving device 7 for moving the bed 5 back and forth in directions indicated by a two-dot chain line arrow in FIG. 1. The movement of the bed 5 is controlled by a movement control unit 9 to follow a body axis MP aligned to the center of the opening of the gantry 1.

When the bed 5 is moved relative to the multi-ring type detector 3, a data collecting unit 11 collects coincidence data (emission data/transmission data) in each position of the bed 5.

The positron CT apparatus in this embodiment is constructed for collecting emission data and transmission data simultaneously and separately.

For collecting emission data and transmission data separately, data is first collected while emitting strong radiation from an external radiation source, not shown, attached to the gantry 1, before giving positron-emitting RI (radioactive isotope) to the patient M. Subsequently, emission data is collected with the radiation from the external radiation source stopped. Since the emission data is under the influences of absorption by the patient M, absorption correcting data is derived from transmission data to correct the influences. For collecting emission data and transmission data simultaneously, positron-emitting RI is first given to the patient M, and then transmission data and emission data are collected simultaneously while emitting strong radiation from the external radiation source not shown.

A processing unit 13 corresponding to a computer has a memory, CPU and so on for controlling the movement control unit 9 and data collecting unit 11 noted above, and executing an examination scheduling program for the positron CT apparatus as described hereinafter. The processing unit 13 has also a clock function for giving an indication according to the present time on a schedule as described hereinafter. Contents and functions of files constituting the examination scheduling program are displayed on a display unit 15 in the form of a CRT, liquid crystal display or the like. Instructions for an examination and the like of each patient are inputted through a mouse 17 which is an example of pointing devices, and through a keyboard 19.

The functions of the examination scheduling program for the positron CT apparatus are interrelated as shown in FIG. 2.

“Functions constantly used in time of collection 21” include function call X, today's schedule A and collection panels P. The “function call X” calls a medication dispensing amount calculation L which is a function to calculate an amount of medication, for example, or calls an examination schedule display/edit F described hereinafter. “Today's schedule A” displays today's examination schedule. “Collection panels P” are allocated to different patients, and accompany the today's schedule A. Today's schedule A is correlated with a calibration M which stores data produced in time of calibrating the positron CT apparatus.

“Functions used for examination reservations 23” include examination search E, examination schedule display/edit F and examination schedule display/edit for particular day G. “Examination search E” searches the examination schedule by various keywords. “Examination schedule display/edit F” is a function for displaying and editing a weekly or monthly examination schedule. “Examination schedule display/edit for particular day G” is a function for displaying and editing an examination schedule for a particular day, edited by the examination schedule display/edit F. Examination schedule display/edit F, examination search E and examination schedule display/edit for particular day G are correlated with one another.

“Functions relating to patients 25” include patient information H, study series information J and actual measurements N and examination results O. “Patient information H” is a function for inputting and editing information on each patient on a patient list K. “Study series information J” has a function for setting almost all contents of examination, of which parameters are stored in detailed parameter information Q. “Actual measurements N” store times when medication was actually given as time stamps independently of schedules. “Examination results O” store transmission/emission data collected for each patient, and images reconstructed from these data. The patient information H, study series information J, actual measurements N and examination results O are correlated with one another for each patient.

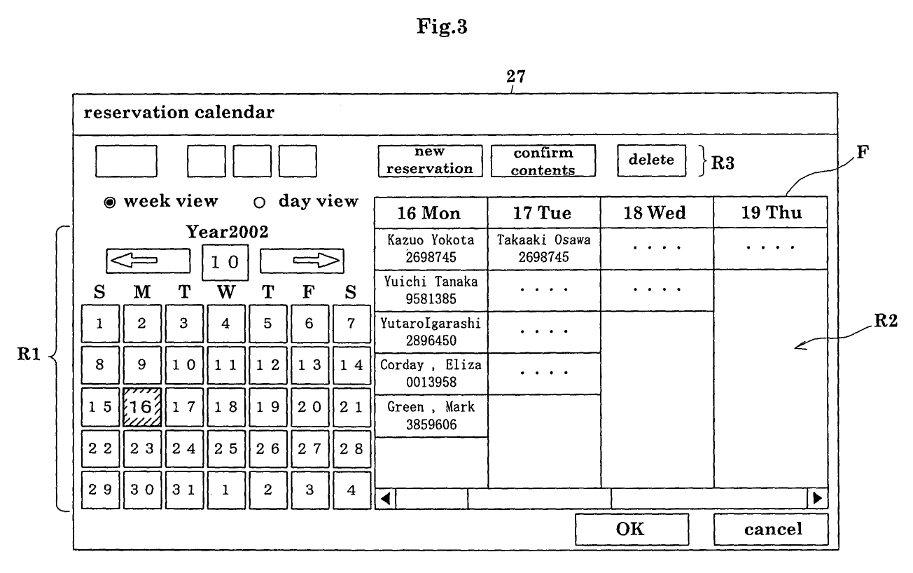

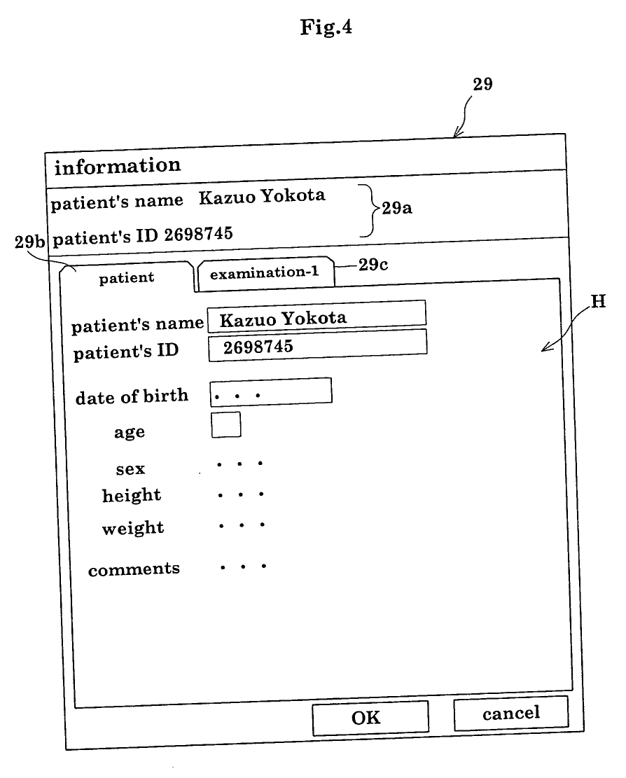

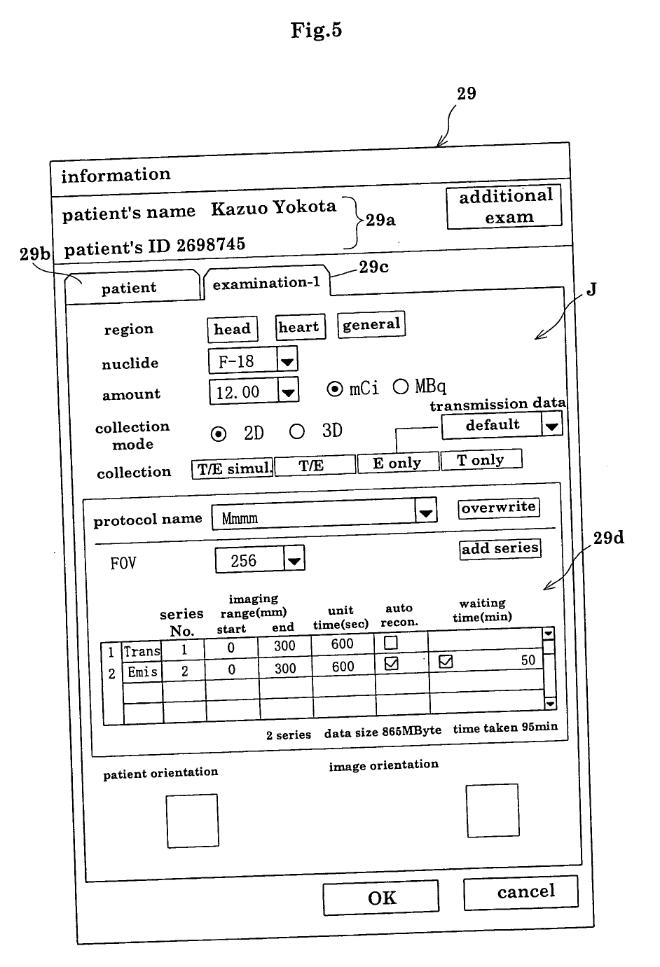

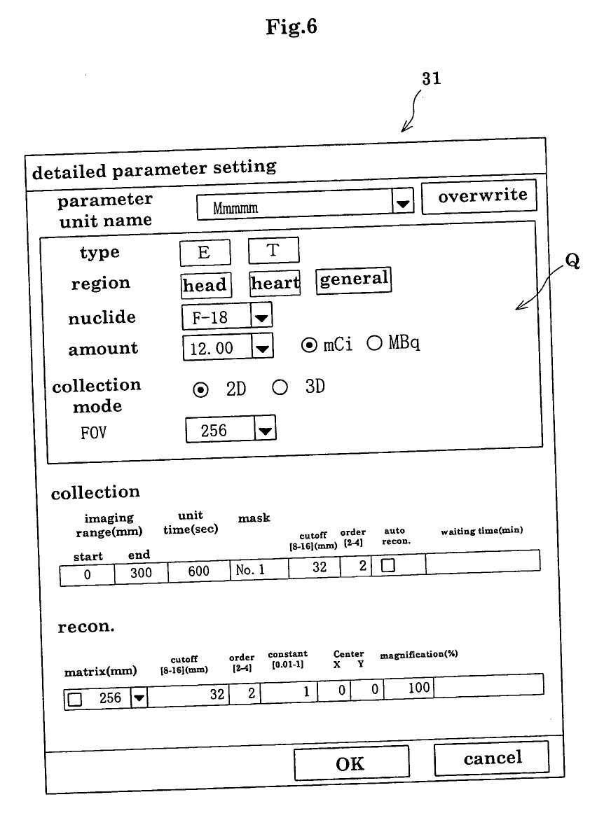

Reference is made to FIGS. 3 through 6. FIG. 3 is a view showing contents of a reservation calendar displayed in a week view. FIG. 4 is a view showing contents of patient information in a patient information file. FIG. 5 is a view showing contents of study series information in the patient information file. FIG. 6 is a view showing contents of detailed parameter setting information accompanying the study series information in the patient information file.

When the examination schedule display/edit F is called by function call X, as shown in FIG. 3, a reservation calendar 27 is displayed on the display unit 15. On the reservation calendar 27, the examination schedule display/edit F displays and allows editing of a schedule for a day selected in a month, week and day selecting region RI by the operator with the mouse 17 or keyboard 19. When a schedule exists for the day selected, the schedule is displayed along with patients' names in a schedule viewing region R2. Editorial instructions such as entry of a new reservation in the schedule or a deletion therefrom may be effected by using an edit region R3.

When a particular patient's name is selected in the schedule viewing region R2 on the reservation calendar 27, information 29 based on the patient information H and study series information J is displayed as shown in FIG. 4. The patient's name and patient's ID are displayed in a patient region 29a for confirmation. When a patient tab 29b is selected, patient information such as the patient's name, patient's ID, date of birth and age may be displayed and edited. The operator may select a desired location with the mouse 17, and input and/or edit information on the patient through the keyboard 19.

When an examination tab 29c is selected in the information 29, information based on the study series information J is displayed as shown in FIG. 5. With the examination tab 29c selected, settings may be made for a region such as the head or heart, a nuclide, an amount of medication, a collection mode, e.g. 2D or 3D, a collection indicating whether to measure transmission data and emission data simultaneously or separately, a protocol name, a patient's orientation, and an image orientation. Here, different values of the above settings signify different types of examination. A waiting time is set to a waiting time setting section 29d for each type of examination, to fix a constant waiting time from medication to start of the examination.

When selecting or newly creating a protocol name on a drop down list, a detailed parameter setting 31 based on the detailed parameter information Q is displayed as shown in FIG. 6. This is for establishing, under a new name, a set of important parameters included in the information on the examination tab 29c in the above information 29.

An examination reserving operation of the scheduling program for the positron CT apparatus will be described next.

First, the operator selects the examination schedule display/edit F from the function call X. Then, the reservation calendar 27 shown in FIG. 3 is displayed on the display unit 15. In this state, patients' names and other data are inputted for desired days and months according to the order of examinations. At this time, the information 29 shown in FIG. 4 is displayed, and the operator instructs examinations required for the patients.

Next, after completing the input of the patients' names and so on for the desired days, the operator instructs a start of scheduling. Then, the processing unit 13 refers to the examination schedule display/edit F, patient information H and study series information J, and prepares schedules for the days selected. The scheduling is carried out as follows.

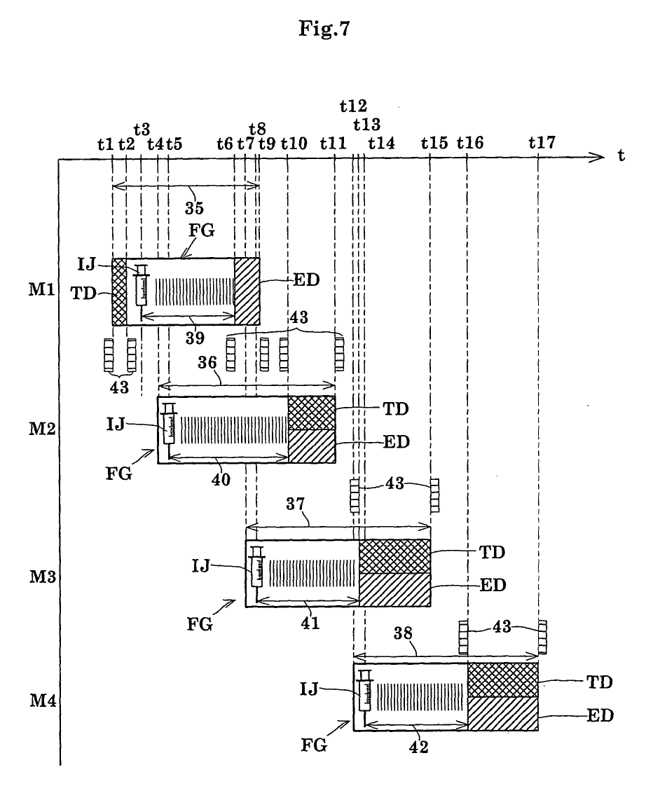

It is assumed here that, as shown in FIG. 7, instructions are given for examinations to be carried out of four patients, i.e. patients M1-M4, in the stated order. For patient M1, transmission data and emission data are to be collected separately. For patients M2-M4, these data are to be collected simultaneously. FIG. 7 is a schematic view showing a scheduling made for designated examinations of the patients and in a designated order of examinations;

Reference FG denotes figures or patterns having time spans according to the types of examination designated for the patients. It is assumed that patients M1-M4 are to receive different types of examination, with time spans 33 having different time spans 35-38 of patterns FG and waiting times 39-42. The information 29 (J) and detailed parameter setting 31 (Q) associated with patients M1-M4 determine the time spans 35-38 of patterns FG, and determine timing of collecting transmission data TD, timing of medication IJ, waiting times 39-42 set for the different types of examination, and timing of collecting emission data ED, in the respective patterns FG.

The processing unit 13 arranges the examinations in the respective patterns FG, i.e. the timing of collecting transmission data TD and the timing of collecting emission data ED, in a way to avoid overlapping in time therebetween. At this time, overlapping in time between the timing of medication according to the information on the contents of examinations and the order of examinations is avoided in a way not to vary the waiting times 39-42 of the respective patients, in other words, in a state of maintaining a fixed waiting time set for each patient according to the type of examination. That is, an arrangement is made without overlapping while maintaining the waiting times fixed. Thus, this scheduling does not employ an arrangement that avoids overlapping by extending and shortening the waiting times.

A schedule for successively examining patients M1-M4 in a way to meet the above conditions forms an arrangement as shown in FIG. 7.

For patient M1, transmission data TD is collected from a point of time t1 to a point of time t2, and then medication IJ is given at a point of time t3. After the waiting time 39 from the point of time t3 to a point of time t6, emission data ED is collected from a point of time t7 to a point of time t9. For patient M2, medication IJ is given at a point of time t5. After the waiting time 40 from the point of time t5 to a point of time t10, transmission data TD and emission data ED are collected from the point of time t10 to a point of time t11. For patients M3 and M4, steps similar to those for patient M2 are taken. As a result, for each of the patients M1-M4 designated by the operator as objects of scheduling, the times of examination and medication are arranged with the waiting time after medication IJ is fixed for each type of examination.

As described above, a schedule is determined to avoid overlapping in time of the timing of medication and the examinations based on the information on the contents and order of the examinations, while fixing a constant waiting time from medication to examination for each patient according to the type of examination. This readily improves the operating ratio of the positron CT apparatus, and uniforms the waiting time for each examination. A re-scheduling may be made easily to cope with an alteration since the current schedule may be grasped immediately only by looking at the arrangement of patterns FG.

In FIG. 7, numeral 43 denotes allowances. A patient M lying on the bed 5 of the positron CT apparatus cannot be replaced with a different patient M in an instant. These allowances 43 are provided by taking into account the time taken in changing the patients M. In the above scheduling, therefore, the processing unit 13 arranges the patterns FG to extend over correspondingly lengthened periods of time.

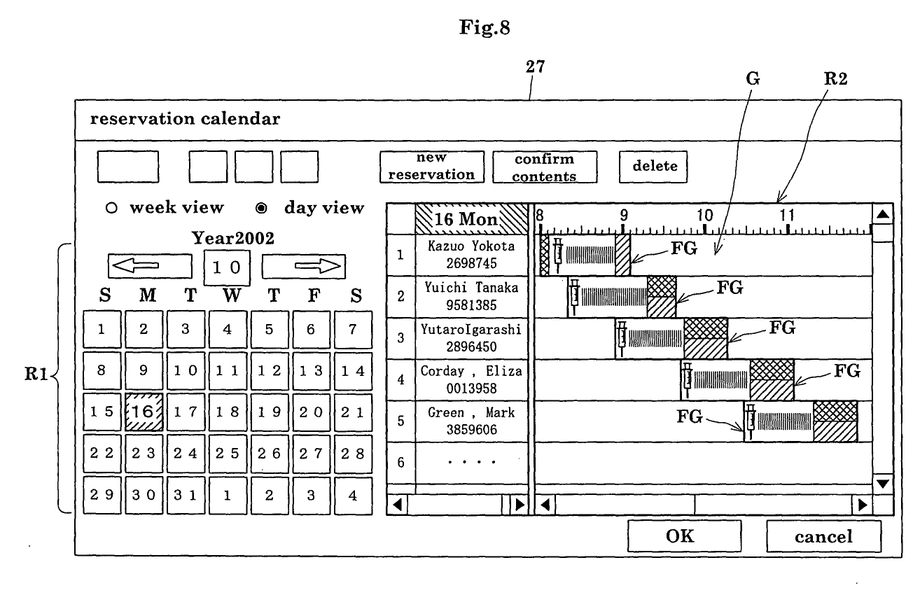

After the processing unit 13 completes the scheduling as described above, the reservation calendar 27 is displayed as shown in FIG. 8. That is, the patterns FG for the respective patients based on the above scheduling results appear in the schedule viewing region R2. FIG. 8 is a view showing contents of the reservation calendar displayed in a day view.

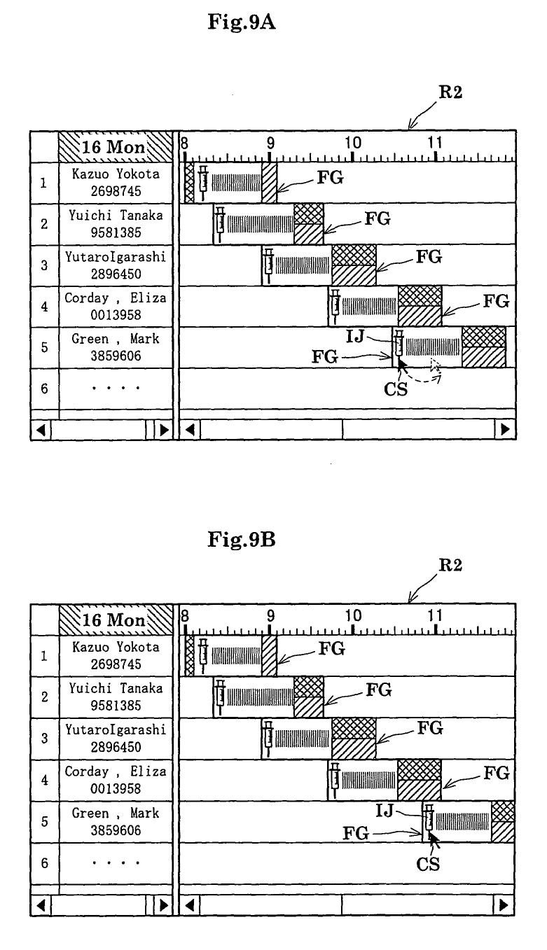

The operator checks the schedule viewing region R2. A necessary alteration may be made easily as shown in FIGS. 9A and 9B. FIGS. 9A and 9B are schematic views showing an alteration made to the schedule on the reservation calendar displayed in the day view.

Assume, for example, that medication cannot be given to a patient at a scheduled time because of an expected time of the patient's visit to the hospital. In this case, the operator first operates the mouse 17 and moves a cursor CS to the pattern FG of the patient to be altered. Then, the operator drags medication IJ to an appropriate time after the patient's arrival at the hospital (FIG. 9A). Next, the processing unit 13 carries out the above scheduling again only for the above patient in the position to which the medication IJ has been dragged. If there is no overlapping, pattern FG will be displayed in that position (FIG. 9B). When the position selected by the dragging is inappropriate, other examinations may automatically be shifted to good positions other than the above position. In addition, priority may be given to the examination arranged by the dragging, with examinations obstructive to this arrangement moved clear thereof. The above function enables the schedule to be altered immediately and easily for each patient, while checking the state of an overall schedule.

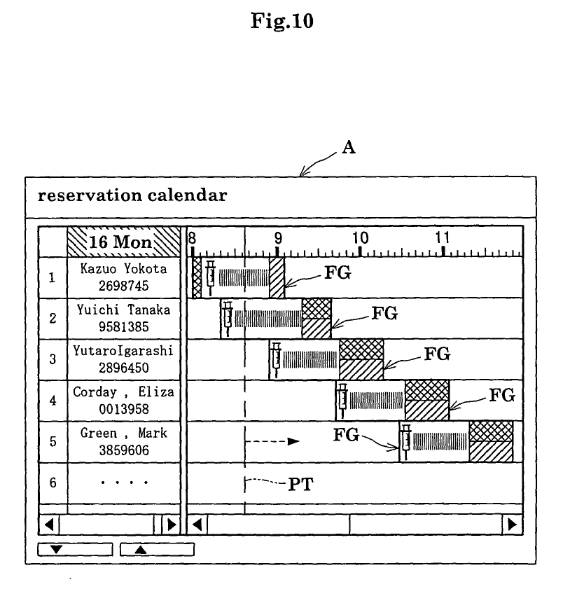

Next, operations carried out on the day for which the above scheduling has been made beforehand will be described with reference to FIG. 10. FIG. 10 is an explanatory view showing movement of the present time on the reservation calendar displayed in the day view.

When the operator selects today's schedule A through the function call X, the processing unit 15 displays today's schedule A on the display unit 15 based on examination schedule display/edit F, patient information H and so on. The processing unit 13 includes a clock function, and displays a present time line PT (two-dot chain line in FIG. 10) reflecting the present time, in superimposition on today's schedule A. This present time line PT is displayed to move with passage of time. Thus, what should be done next is grasped with ease from a timewise positional relationship of line PT with the patterns FG indicating the timing of mediation and the timing of examination.

Medication and the like, which are done manually, may not be carried out reliably according to schedule. It is desirable to take this fact into account and record measurements of the time of actually giving medication, or starting examination as described hereinafter. The processing unit 13 automatically records these actual measurements in actual measurements N when the operator clicks the mouse 17 on a time stamp button, not shown, displayed on the display unit 15. Alternatively, the keyboard 19 may be operated to instruct a time stamp to be stored.

When an actual time of medication differs from a scheduled time, a subsequent schedule should preferably be altered.

Specifically, an alteration is effected through a process of inputting an actual medication time, and a process of comparing a scheduled medication time and the actual medication time. When the comparison shows a disagreement, a process is carried out for creating an examination schedule again. As noted above, medication is an operation performed by a human or for a human, and may not be carried out according to schedule. An actual medication time may deviate from a scheduled time. This may be caused, for example, by a delay in preparing a liquid medicine, or a patient failing to visit the hospital before a scheduled medication time.

Such a situation is determined by comparing an actual medication time and a scheduled medication time. When the result shows a disagreement, a scheduling is carried out again. In this way, a subsequent schedule may be altered automatically, to avoid subsequent examinations becoming hectic.

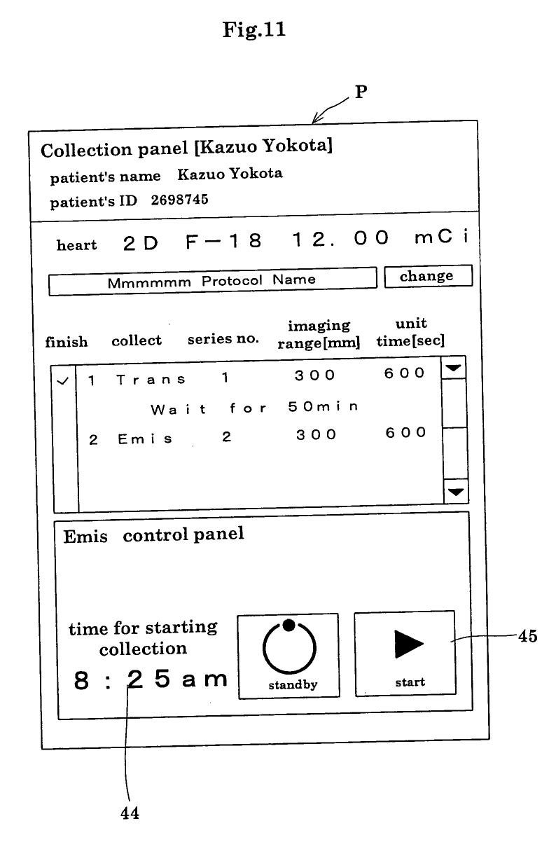

When medication has been performed according to schedule and any one of the waiting times 35-38 has elapsed, an examination by the positron CT apparatus is started. Before each of the waiting times 35-38, a collection panel P as shown in FIG. 11 is displayed on the display unit 15. The panel P includes a scheduled collection starting time 44 which is a time for starting collection of emission data/transmission data (examination time) as scheduled. When the mouse 17 is clicked on a start button 45 displayed, an examination by the positron CT apparatus is started to collect data. The data collected is stored as examination results O associated with the patient, and automatically stored in actual measurements N with an examination time. When an RI distribution image is reconstructed based on the examination result O, its data also is stored in the examination results O.

Thus, a deviation from the schedule can be determined by correlating actual measurements N including actual medication and examination times, and examination results O of collected data. This enables appropriateness of the time management of examinations to be determined easily.

This invention is not limited to the foregoing embodiment, but may be modified as follows:

(1) In the foregoing embodiment, the positron CT apparatus measures transmission data and emission data simultaneously or separately as instructed. The positron CT apparatus may be adapted to examine data only simultaneously or only separately.

(2) The apparatus may be used to carry out only an examination scheduling for each patient. It is not absolutely necessary to establish a correlation between actual measurements including actual medication and examination times, and data collected by the positron CT apparatus.

(3) Instead of altering a schedule by moving patterns on the time chart with the mouse 17, an alteration may be made by directly inputting a time from the keyboard 19 or the like.

(4) In the foregoing embodiment, a schedule for each patient is displayed in the form of a figure or pattern FG on the time chart, and the present time line PT is displayed to move on the time chart with progress of time. Instead, only the present time may be displayed.

(5) Instead of displaying a schedule for each patient in the form of a pattern having a time span according to the type of examination designated for the patient, the schedule may be expressed by a character string.

(6) FIGS. 3 through 6 and 8 through 11 show display modes only by way of example. This invention is not limited to these display modes.

(7) This invention is not limited to the positron CT apparatus, but is applicable also to a nuclear medical examination apparatus such as a gamma camera.

This invention may be embodied in other specific forms without departing from the spirit or essential attributes thereof and, accordingly, reference should be made to the appended claims, rather than to the foregoing specification, as indicating the scope of the invention.

What is claimed is:

1. An examination scheduling program for a nuclear medical examination apparatus for causing a computer to create a schedule for each patient including an examination by the nuclear medical examination apparatus and a medication accompanying the examination, said program comprising:
a step of fetching information on contents of the examination for each patient and an order of examinations; and
a step of creating an examination schedule to avoid overlapping in time of timing of the medication and the examinations according to said information on said contents of the examination and said order of examinations, while maintaining fixed a waiting time from the medication to the examination set for each patient according to a type of examination.

2. An examination scheduling program as defined in claim 1, wherein said schedule for each patient is expressed by a pattern having a time span according to the type of examination, said pattern presenting the timing of the medication, the waiting time and the contents of the examination.

3. An examination scheduling program as defined in claim 1, wherein said schedule for each patient is displayed in form of a pattern on a time chart, with a line representing present time displayed to move on the time chart with progress of time.

4. An examination scheduling program as defined in claim 2, wherein said schedule for each patient is displayed in form of a pattern on a time chart, with a line representing present time displayed to move on the time chart with progress of time.

5. An examination scheduling program as defined in claim 1, wherein said schedule is altered by moving said pattern on said time chart with a pointing device.

6. An examination scheduling program as defined in claim 2, wherein said schedule is altered by moving said pattern on said time chart with a pointing device.

7. An examination scheduling program as defined in claim 3, wherein said schedule is altered by moving said pattern on said time chart with a pointing device.

8. An examination scheduling program as defined in claim 4, wherein said schedule is altered by moving said pattern on said time chart with a pointing device.

9. An examination scheduling program as defined in claim 1, wherein said schedule for each patient is under control, and a correlation is made between actual measurements including actual medication and examination times, and data collected by said nuclear medical examination apparatus.

10. An examination scheduling program as defined in claim 2, wherein said schedule for each patient is under control, and a correlation is made between actual measurements including actual medication and examination times, and data collected by said nuclear medical examination apparatus.

11. An examination scheduling program as defined in claim 3, wherein said schedule for each patient is under control, and a correlation is made between actual measurements including actual medication and examination times, and data collected by said nuclear medical examination apparatus.

12. An examination scheduling program as defined in claim 4, wherein said schedule for each patient is under control, and a correlation is made between actual measurements including actual medication and examination times, and data collected by said nuclear medical examination apparatus.

13. An examination scheduling program as defined in claim 5, wherein said schedule for each patient is under control, and a correlation is made between actual measurements including actual medication and examination times, and data collected by said nuclear medical examination apparatus.

14. An examination scheduling program as defined in claim 6, wherein said schedule for each patient is under control, and a correlation is made between actual measurements including actual medication and examination times, and data collected by said nuclear medical examination apparatus.

15. An examination scheduling program as defined in claim 7, wherein said schedule for each patient is under control, and a correlation is made between actual measurements including actual medication and examination times, and data collected by said nuclear medical examination apparatus.

16. An examination scheduling program as defined in claim 8, wherein said schedule for each patient is under control, and a correlation is made between actual measurements including actual medication and examination times, and data collected by said nuclear medical examination apparatus.

17. An examination scheduling program as defined in claim 1, further comprising a step of inputting an actual medication time, a step of comparing a scheduled medication time and said actual medication time, and a step of creating an examination schedule all over again when said step of comparing shows a disagreement.

18. An examination scheduling program as defined in claim 2, further comprising a step of inputting an actual medication time, a step of comparing a scheduled medication time and said actual medication time, and a step of creating an examination schedule all over again when said step of comparing shows a disagreement.

19. An examination scheduling program as defined in claim 3, further comprising a step of inputting an actual medication time, a step of comparing a scheduled medication time and said actual medication time, and a step of creating an examination schedule all over again when said step of comparing shows a disagreement.

20. An examination scheduling program as defined in claim 5, further comprising a step of inputting an actual medication time, a step of comparing a scheduled medication time and said actual medication time, and a step of creating an examination schedule all over again when said step of comparing shows a disagreement.
